(19) United States
(12) Patent Application Publication
(10) Pub. No.: US 2025/0236074 A1
(43) Pub. Date: Jul. 24, 2025

(54) BIOMECHANICAL SHOE SOLES INSPIRED BY BIOLOGICAL LATTICES AND METHOD OF MAKING THEREOF

(71) Applicant: University of Massachusetts, Westborough, MA (US)

(72) Inventors: Seth W. Donahue, Hadley, MA (US); Molly K. Costa, Hadley, MA (US); Rachel Donoghue, Hadley, MA (US)

(73) Assignee: University of Massachusetts, Westborough, MA (US)

(21) Appl. No.: 19/174,213

(22) Filed: Apr. 9, 2025

Related U.S. Application Data
(63) Continuation-in-part of application No. 18/744,761, filed on Jun. 17, 2024.
(60) Provisional application No. 63/631,640, filed on Apr. 9, 2024.
(60) Provisional application No. 63/508,590, filed on Jun. 16, 2023.

(51) Int. Cl. B29C 64/393; B33Y 50/02; G06T 3/40; G06T 17/20

(52) U.S. Cl. CPC B29C 64/393; B33Y 50/02; G06T 3/40; G06T 17/205

(57) ABSTRACT

A shoe sole having an energy absorbing lattice structure and method of making thereof is disclosed. The energy absorbing structure comprises an energy absorbing lattice structure having an irregular, but not random, lattice pattern. The irregular lattice pattern of the energy absorbing lattice structure may be a Voronoi cell pattern, which may be derived from a biological lattice such as bovid skull horncore morphology for example. The bioinspired lattices of the shoe sole may be configured/tailored for two purposes: 1) large energy absorption properties and 2) biomechanically controlling the position of the foot to further control joint (e.g., ankle, knee, hip, spine) loading, forces, and pain.

### CROSS-REFERENCE TO RELATED APPLICATIONS

This patent document claims priority to earlier filed U.S. Provisional Application Ser. No. 63/631,640, filed on Apr. 9, 2024, and is a continuation-in-part of U.S. Non-Provisional application Ser. No. 18/744,761, filed on Jun. 17, 2024, which claims priority to U.S. Provisional Application Ser. No. 63/508,590, filed on Jun. 16, 2023, the entire contents of which are incorporated herein by reference.

### STATEMENT REGARDING FEDERALLY SPONSORED RESEARCH OR DEVELOPMENT

N/A

### BACKGROUND OF THE INVENTION

### 1. Field of the Invention

The present patent document is directed generally to shoe soles having energy absorbing lattice structures and more particularly to improved energy absorbing structures derived from biological morphology, such as bovid horncores, and methods of making thereof.

### 2. Background of the Related Art

Energy absorbing lattices in shoe soles are desirable to provide proper impact energy absorption for physical activity. It is also desirable to be able to tailor inhomogeneous, but architected lattice porosity throughout a shoe sole, to minimize material use and weight and to control foot position to ensure proper biomechanics of the joints in the lower limbs. The structures described herein provide these desirable qualities as alternatives to lower energy absorbing and less architecturally tailorable prior art materials and methods.

Accordingly, there is a need in the art for improved energy absorbing structures that are highly architecturally tailorable inexpensive and lightweight to overcome limitations of prior art materials and methods.

### SUMMARY OF THE INVENTION

Biological bony lattices inherent in certain animal morphologies, such as the horncores of ramming bovids (e.g., Rocky Mountain Bighorn Sheep), evolved unique architectures to absorb high energy impacts. Irregular bony lattice-like structures are important for absorbing impact energy and protecting the brain from damaging accelerations as has been demonstrated by simulated head impacts using in silico finite element modeling.

For the shoe sole described here, bioinspired lattices may be incorporated into shoes soles for two purposes: 1) large energy absorption properties and 2) biomechanically controlling the position of the foot to further control joint (e.g., ankle, knee, hip, spine) loading, forces, and pain. For the former purpose (i.e., purpose 1) the lattice porosity (and therefore stiffness) may be varied throughout the shoe sole to preferentially place material where it is most needed for energy absorption (e.g., heel) and place less material where it is not needed as much (e.g., arch) to minimize the weight of the sole. The latter (i.e., purpose 2) will be achieved by varying the bioinspired Voronoi lattice structure by using different point clouds (i.e. architecture of focal bony horncore regions), lattice porosities, lattice strut thicknesses and shapes (e.g., plate-like, rod-like), and other architectural parameters like connectivity, throughout the shoe sole to achieve the desired biomechanical control of foot posture.

### BRIEF DESCRIPTION OF THE DRAWINGS

These and other features, aspects, and advantages of the present invention will become better understood with reference to the following description, appended claims, and accompanying drawings where:

FIG. 1 is a perspective view of an image of a bovid skull, showing the horn and horncore morphology;

FIG. 2 shows a partial longitudinal section from a CT scan of the irregular bony lattice (a.k.a., velar bone) within the cortical shell of a horncore;

FIG. 3 shows a digitized image of a 3D rendering of the velar bone lattice within a bovid horncore, with multiple velar cubes cropped from along the length of the horn core;

FIG. 4 shows an exemplary image of a velar cube imported into ImageJ software, where floating structures and gaps are filled between struts;

FIG. 5A shows an image of a step of calculating Voronoi cell center points of a velar cube.

FIG. 5B shows an image of a lattice structure formed by interconnecting said Voronoi cell center points of a velar cube;

FIG. 6 shows an exemplary point cloud used for creating a bioinspired velar lattice structure;

FIG. 7A shows an exemplary point cloud with edges cropped to reduce instances of flat sheets;

FIG. 7B shows an exemplary cropped point cloud that is scaled down for resulting lower porosity in a recreated lattice structures;

FIG. 8 shows top view of an exemplary shoe sole where undesirable flat sheets have formed;

FIG. 9A shows a scan of a shoe upper that is desired to attach a shoe sole of the preset invention thereto;

FIG. 9B shows a step of using a Subd sphere around a curve of the show upper of FIG. 9A;

FIG. 9C shows a step of creating a series of plain cuts along the curve formed in FIG. 9B;

FIGS. 10A, 10B, and 10C show a series of steps of forming a wireframe shoe sole configured to attach to the show upper;

FIG. 11A shows a top and left side view of a wireframe model of a shoe sole configured to attached to a shoe upper;

FIG. 11B shows a bottom perspective view of a wireframe model of a shoe sole configured to attached to a scan of a shoe upper;

FIG. 11C shows a model of the shoe sole connected to the scan of the shoe upper;

FIG. 12A shows a top view of a single cropped point cloud;

FIG. 12B shows a front view of a single cropped point cloud;

FIG. 12C shows a top view of a staggered point clouds to avoid high porosity and/or through-hole in the shoe sole;

FIG. 12D shows a front view of a staggered point clouds to avoid high porosity and/or through-hole in the shoe sole;

FIG. 13A shows a top view of placing a wireframe of a shoe sole over a staggered point cloud;

FIG. 13B shows a side view of placing a wireframe of a shoe sole over a staggered point cloud;

FIG. 14A shows an exemplary velar lattice structure created from the staggered point cloud contained within the wireframe shoe sole, illustrated in FIGS. 13A and 13B;

FIG. 14B shows selecting excess geometry to remove from the exemplary velar lattice structure;

FIG. 14C shows the resulting exemplary velar lattice structure after discarding selected excess geometry from the lattice;

FIG. 15A shows a top and side perspective view of an exemplary velar lattice structure formed into a shoe sole using the method of the present invention;

FIG. 15B shows a top view of an exemplary velar lattice structure formed into a shoe sole using the method of the present invention;

FIG. 16 shows a top view of an exemplary lattice structure formed into show sole in accordance with the method of the present invention further comprising a ribbon section formed to attach the shoe sole to a shoe upper;

FIGS. 17A, 17B, and 17C show a series of steps of forming a bottom plate onto the shoe sole to facilitate attachment of a shoe tread to the shoe sole;

FIG. 18 shows a diagram of a method of making a variable stiffness shoe sole, where a shoe sole shape is populated using two differently scaled bioinspired Voronoi point clouds to produce a low porosity, high stiffness lateral region (A) and a high porosity, low stiffness medial region (B);

FIG. 19 shows an embodiment of a 3D printed show sole made in accordance with the methods disclosed herein with variable stiffness at selected test locations in the toe (A), arch (B), and heel (C) regions of the shoe sole;

FIGS. 20A and 20B show experimental results of test trials of a shoe soles designed to have uniform lateral and medial stiffness (A) and a shoe sole (shown in FIG. 19) designed to have increased lateral stiffness compared to the medial stiffness (B); and

FIG. 21 shows an embodiment of a shoe sole having a lateral wedge, incorporated into the overall shape of the sole containing the bioinspired lattice network, to control foot position.

### DESCRIPTION OF THE PREFERRED EMBODIMENT

The present patent document discloses a shoe sole having an energy absorbing lattice structure and method of making thereof, wherein the energy absorbing lattice structure comprises an irregular, but not random, lattice pattern. The irregular lattice pattern may comprise 2D tessellations to form an irregular, but not random, distribution of asymmetric polygons. The irregular lattice pattern of the energy absorbing lattice structure may also comprise 3D tessellations to form an irregular, but not random, distribution of asymmetric polyhedral shapes. The irregular lattice pattern of the energy absorbing lattice structure may comprise a Voronoi cell pattern, which may be derived from a biological lattice, such as a bovid skull horncore morphology. The shoe sole may further include an upper substrate to enable attachment to a shoe upper, and a bottom plate for attaching a shoe tread thereto, such as with an adhesive or glue as is known in the art. The shoe sole may be manufactured via an additive manufacturing process such as 3D printing, making the shoe sole cost effective and rapid.

The use of varying the properties of the irregular lattice structure throughout the sole to control foot position to control joint position, forces, and pain is more tailorable than using variable stiffness foams, which typically only offer two different foam densities, and therefore stiffnesses, per shoe sole.

Various shoe sole designs that could be attached the various shoe sole uppers for treating various foot abnormalities including, but not limited to flat feet, varus foot, valgus foot, foot pronation, foot supination, and the like.

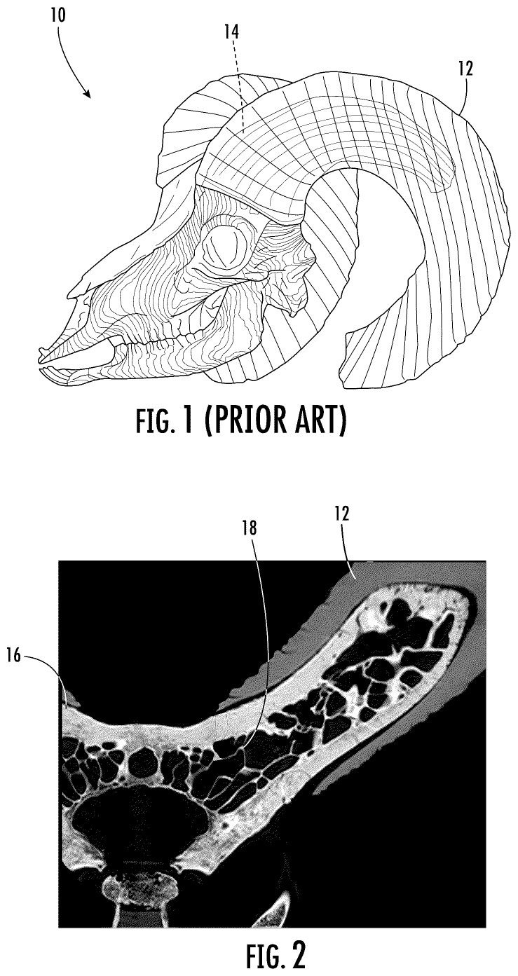

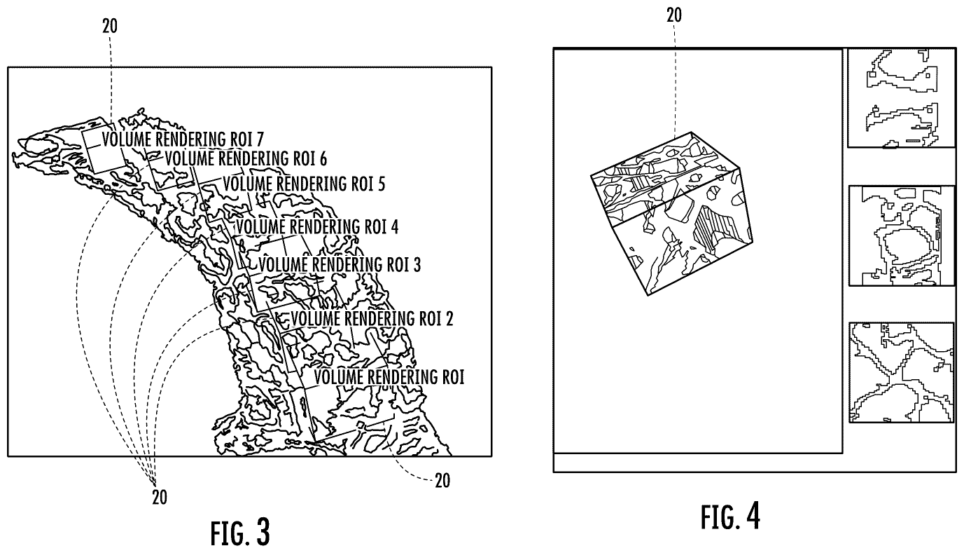

Referring now to FIG. 1, bighorn sheep skulls 10 were provided for research purposes by the state of Colorado Department of Natural Resources under Colorado Parks and Wildlife scientific collection license number 14SALV2052A2. The skulls 10 have a horn 12 that has a horncore 14. As shown in FIG. 2, a CT scan shows the bone architectures from the horn's 12 horncores 14, including the cortical bone shell 16 and horncore velar bone lattice 18. Referring to FIG. 3, cropped cubes 20 along the length of the full horncore 14 may be obtained at various locations using 3DSlicer software to select areas, such as those that receive high compression forces, to obtain bony lattice regions to provide Vornoi point clouds 26 for designing bioinspired lattices to perform specific mechanical functions (e.g., high stiffness or energy absorption during compressive loading). Finite element analysis techniques may be used to determine compressive properties of each cropped cube 20 to aid selection for use in creation of the shoe sole described herein.

Referring to FIG. 4, Seg3D was used to remove floating architecture and fill gaps between struts created.

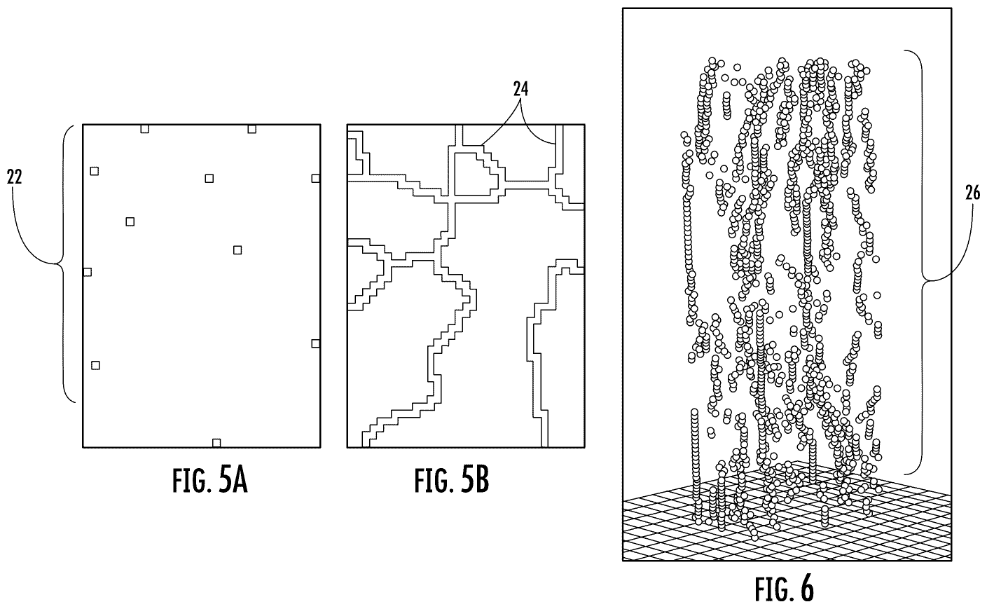

Referring to FIG. 5A and 5B, each cropped cube 20 may be imported to ImageJ software where the velar architecture may be recreated. In particular, the Delaunay-Voronoi command in ImageJ may be used to split the images by lines 22 of points 24 that have equal distance to the borders of the two nearest seed points, creating Voronoi cells. The Ultimate Points command may be used to define the center point of each Voronoi cell. As shown in FIG. 6, a point cloud 26 may be generated from the recreated velar structure.

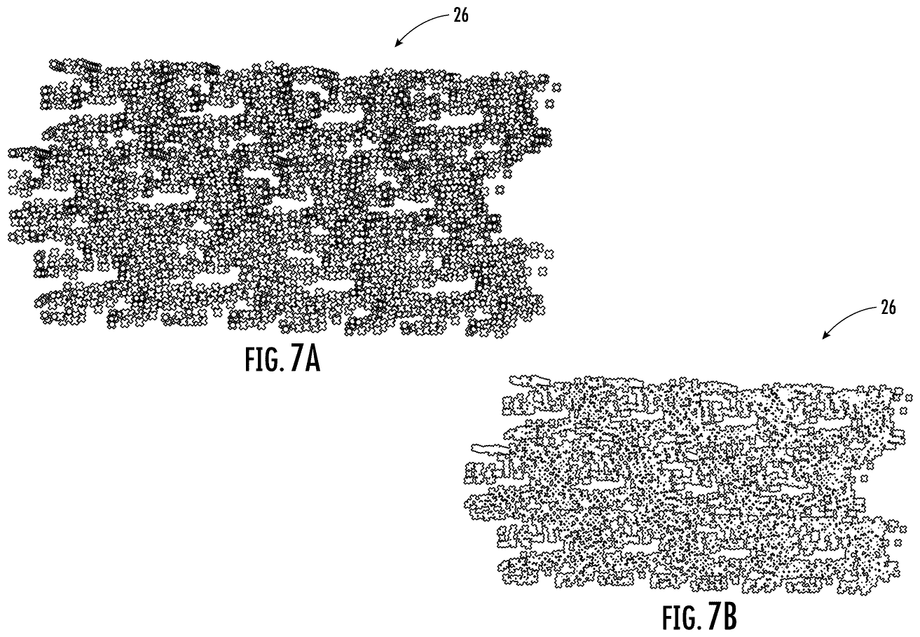

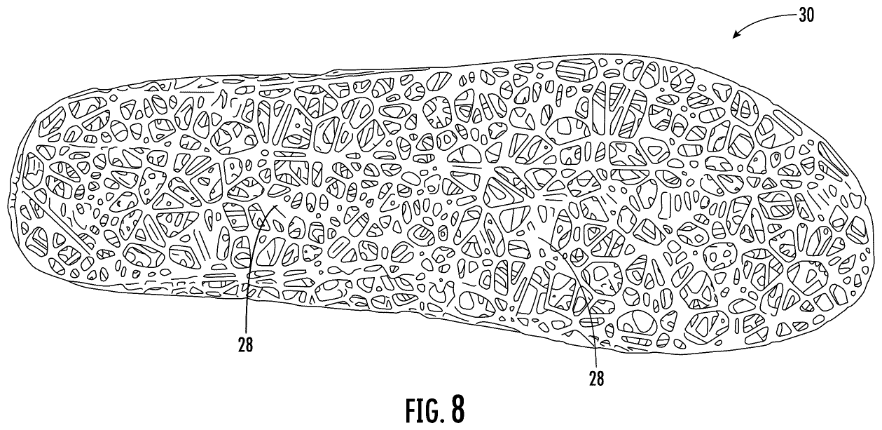

Referring to FIG. 7A, the edges of the point cloud 26 may be cropped to reduce instances of flat sheets 28 forming (best seen in FIG. 8). Small Voronoi cells may “fuse” together if they are too close to one another.

Referring to FIG. 7B the cropped point cloud 26 may then be scaled down to achieve lower porosity, using the scale command in Grasshopper software. Different scaling factors may be used for different sections of the shoe sole model 30 to achieve custom foot support. Reference to a foot pressure map may be used to guide the scale factors to achieve the desired properties (e.g., stiffness) within discrete locations of a shoe sole 30. As will be discussed further below, the same or a different point cloud 26 may be layered together to achieve the desired properties throughout the shoe sole model 30.

As will be described in greater detail below, the shoe sole model 30 may be designed by using Rhinoceros 3D modeling software. A 3D scan of a shoe upper 32 may be imported into the software. From there, a solid sphere 34 may be created around the scan and trimmed using the bottom of the shoe upper 32 as a guide so they fit together once 3D printed. Control points may be created around the trimmed sphere and used to manipulate the sphere 32 into a shoe sole shape that fits the shoe upper 32.

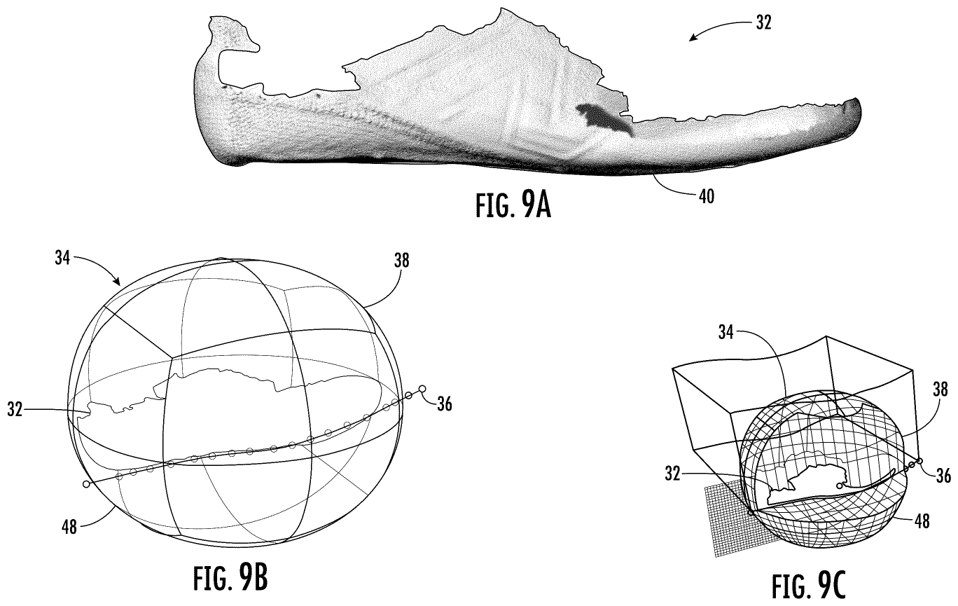

Referring now to FIG. 9A, a scan of a shoe upper 32 is shown generally for which a complimentary shoe sole 30 may be designed in accordance with the present method. As illustrated in FIG. 9B, a sphere 34 may be created using Subd is created around the scan of the shoe upper 32. A curve 36 may be used as a guide to cut away the top section 38 of the sphere 32. FIG. 9C shows the Wirecut command 42 being used to create a series of plain cuts along the curve 36, thus forming a complimentary contoured surface that will fit to the bottom 40 of the scan of the shoe upper 32.

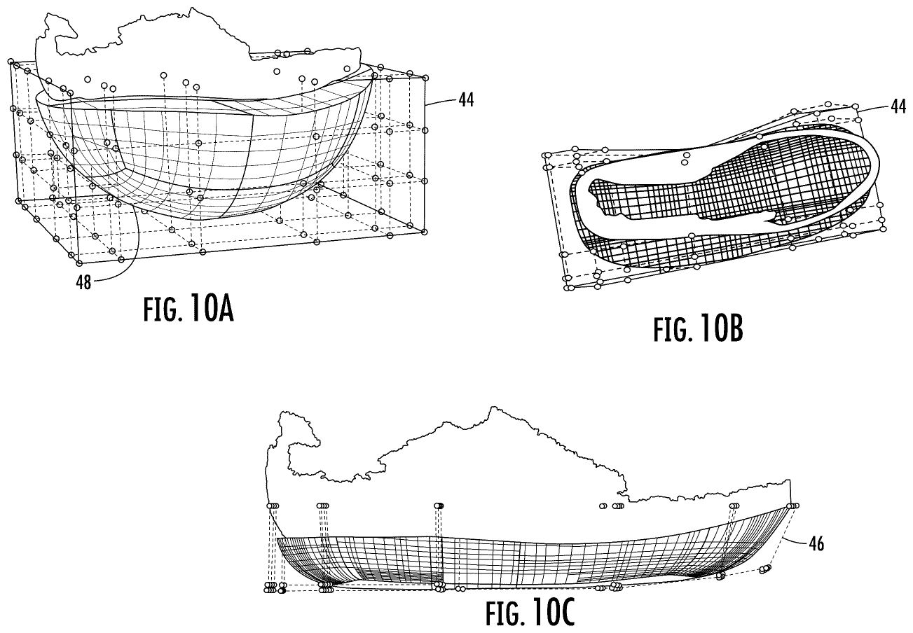

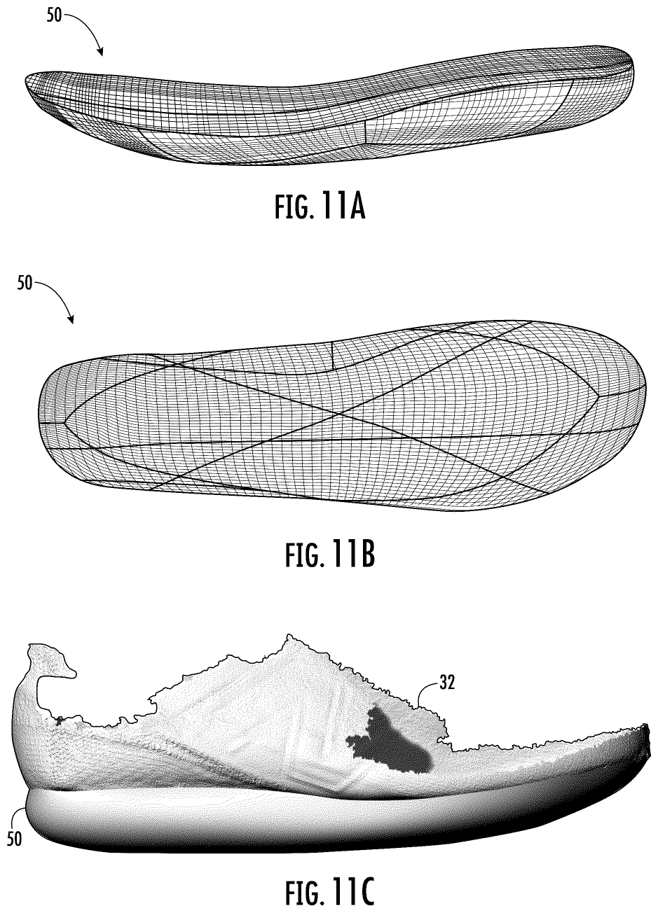

Referring to FIGS. 10A-10C, cage edit command 44 may be used around a bottom portion 48 of the sphere 34 to create a plurality of individual control points along the bottom of the sphere. Scale 1D command may be subsequently sued to manipulate the bottom 48 of the sphere 34 into a desired shoe sole shape 50 (Best seen in FIGS. 11A and 11B).

The resulting shoe shole shape 50 matingly connects to the scan of the shoe upper 32 at 40 of shoe in FIG. 11C.

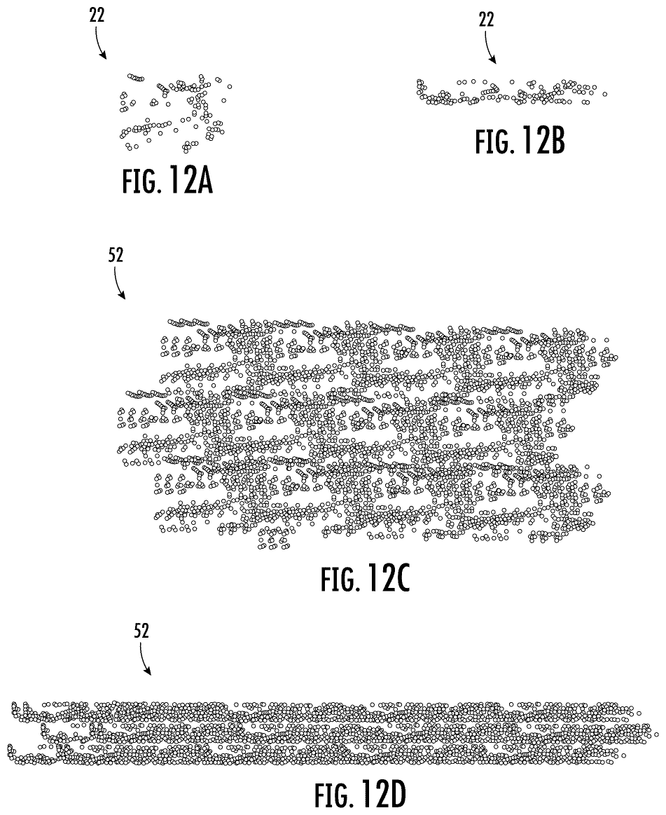

Referring to FIGS. 12A and12B, a top view and front view of the cropped point cloud 22 illustrated in FIG. 6, are shown respectively. As mentioned earlier, two points clouds 22 (either the same or from different lattices) may be layered and staggered to form a staggered point cloud 52 (as shown in FIGS. 12C and 12D). The staggering of the points avoids sections of high porosity and sections where pores may form a through-hole in the resulting lattice.

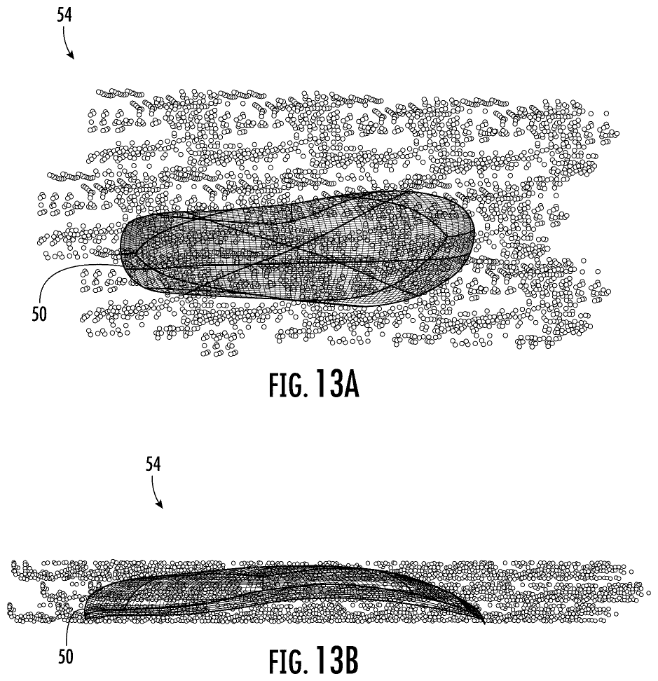

Referring to FIGS. 13A and 13B, the model shoe sole shape 50 is populated with variable bioinspired Voronoi lattices by stacking point clouds 52 from one or multiple bioinspired Voronoi cell structures, such as horncore samples 14, on top of and next to each other to form a master point cloud 54 that is larger than the shoe sole shape 50 boundary. Different porosities can be created in the shoe sole shape 50 by scaling point clouds in certain regions of the master point cloud 54 (e.g. the heel) for added or reduced stiffness. The shoe sole shape 50 boundary may then be placed over the master point cloud 54 and the master point cloud 54 and shoe sole shape 50 boundary are added to a script to fabricate the lattice structure within the organic volume. The Voronoi script takes the master point cloud 54 and the shoe sole shape 50 boundary and computes a Voronoi tessellation based on the position of the points in the master point cloud 54 (see e.g. https://discourse.mcneel.com/t/3d-voronoi/91029 and VoronoiSPherre_re.gh, which are incorporated herein by reference). The Voronoi script calculates which Voronoi cells reside within the model shoe sole shape 50 boundary and discards the rest. Additional functions are used to isolate only the edges of the Voronoi tesellation and change the shape/diameter size of the resulting lattice struts.

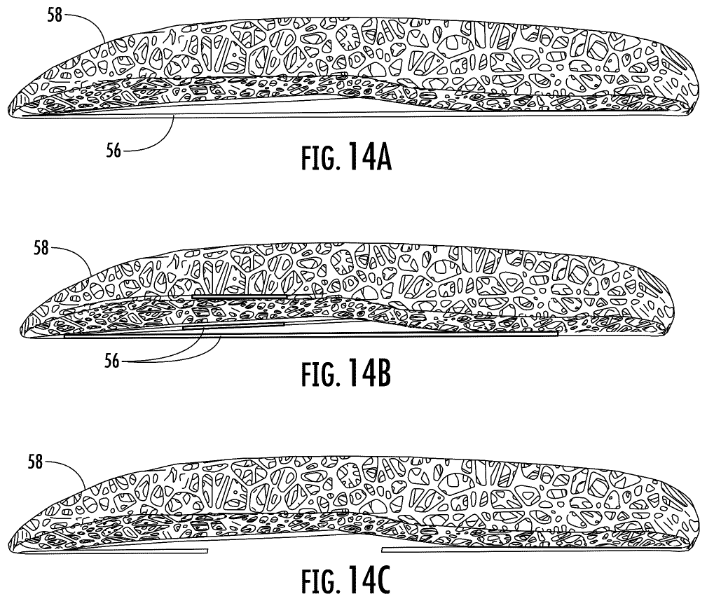

Referring to FIGS. 14A-14C, Meshmixer may be used to inspect and remove geometry 56 from the resulting Voronoi shoe sole model to ensure that the shoe sole model 58 is capable of being additively manufactured, such as through 3D printing. In particular, the Inspect command may be used to identify invalid lattice structure (FIG. 14A), the Select command (FIG. 14B) to select for removal, and finally, the Discard comment (FIG. 14C) to remove the selected geometry.

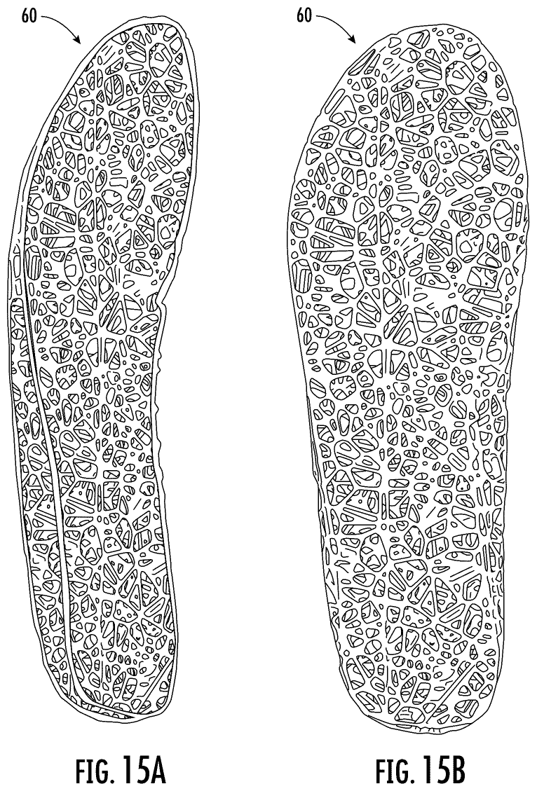

After these operations, the resulting shoe sole model 60, illustrated in FIGS. 15A and 15B, should have an ideal porosity and be ready for additive manufacturing.

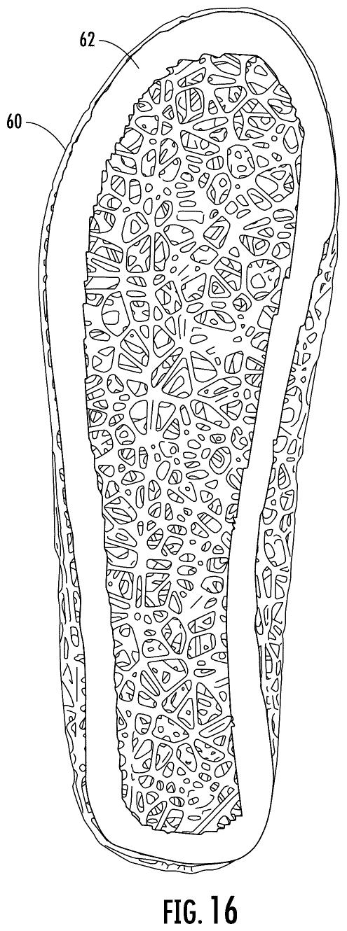

Referring to FIG. 16, optionally, an upper substrate 62 may be formed on the shoe sole model 60 and the resulting additively manufactured shoe sole, to permit the manufactured shoe sole to be affixed to the shoe upper 32, such as with an adhesive or glue. In one embodiment, the upper substrate 62 may be a ribbon formed about an outer edge of an upper surface of the shoe sole.

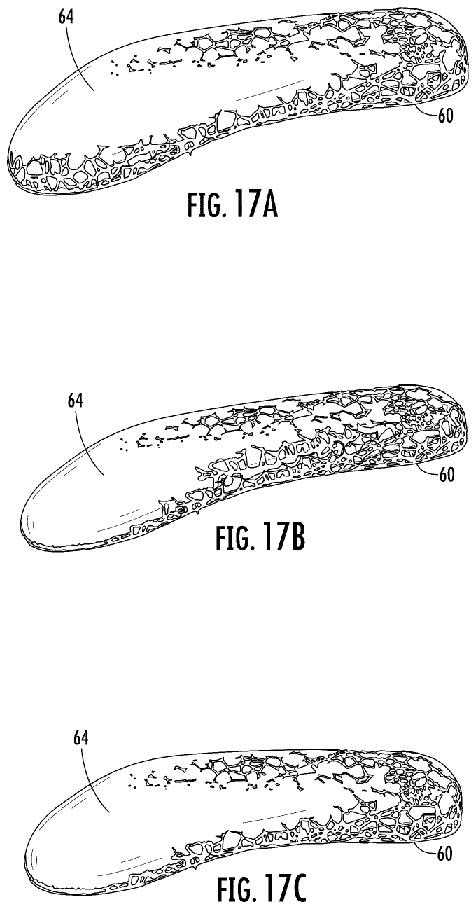

Referring to FIGS. 17A-17C, a bottom plate 64 may be formed to attach a shoe tread thereto. By using Select, Discard, and Inspector commands, the shoe sole model 60 may be finalized for additive manufacturing.

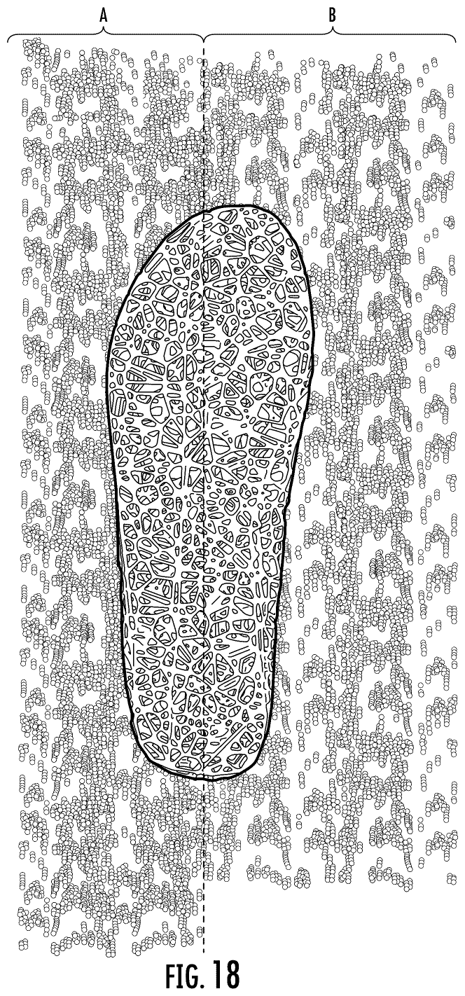

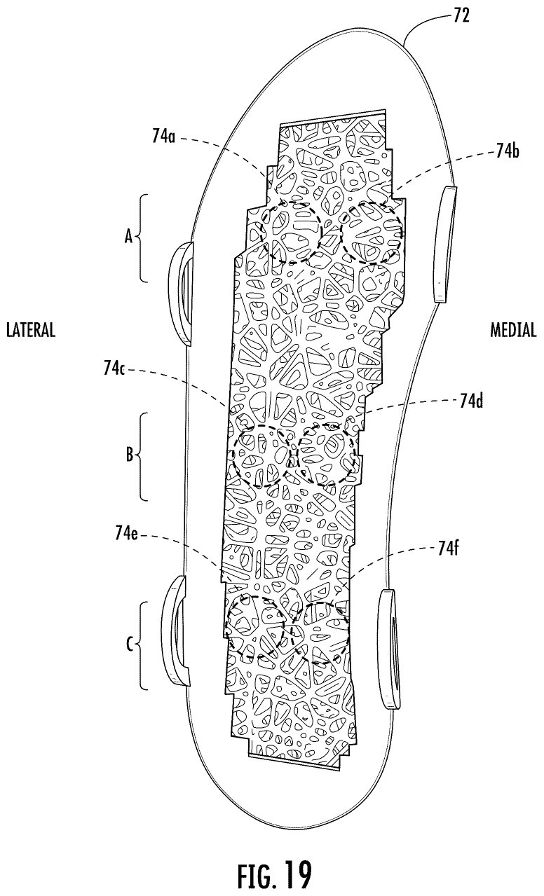

Referring to FIG. 18, a method of making a variable stiffness shoe sole is shown. A shoe sole shape 66 populated using two differently scaled bioinspired Voronoi point clouds 68, 70 to achieve a less porous (more stiff) bioinspired lattice in the lateral compartment (A) and more porous bioinspired lattice (less stiff) in the medial compartment (B). Lateral and medial porosities can be adjusted to achieve any level of variable stiffnesses between the medial and lateral compartments.

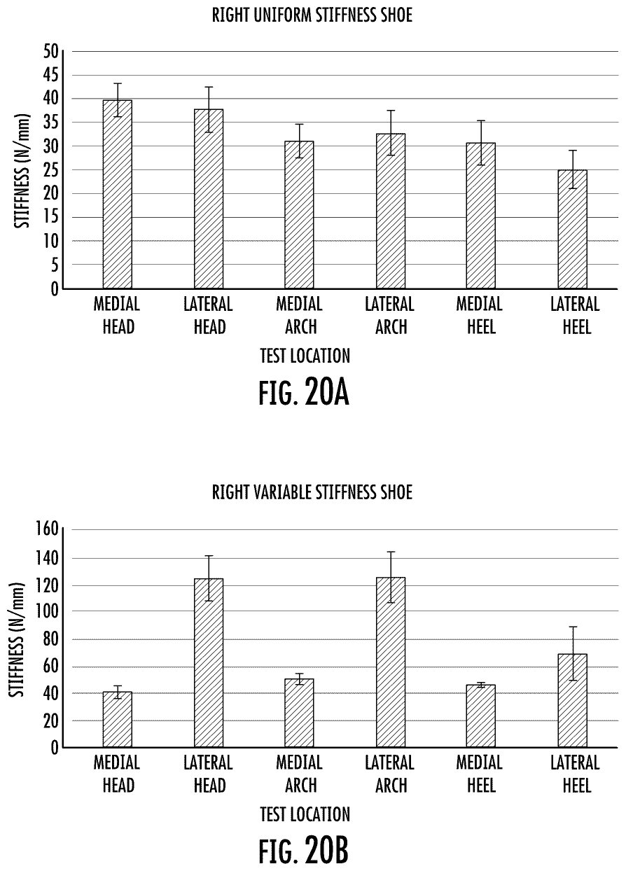

Referring to FIG. 19, a 3D printed proof of concept 72 was created for mechanical testing. Uniform and variable stiffness shoe soles were 3D printed in Flexa Grey TPU (Sinteret). Compression testing was done to determine the stiffnesses of the lateral (52% porosity) and medial (70% porosity) compartments. Six test locations 74a, 74b, 74c, 74d, 74e, 74f were chosen: locations in both the lateral and medial compartments of the toe (A), arch (B), and heel (C) regions of the soles as circled in the image. Three test trials were done on each location. As shown in FIGS. 20A and 20B, the stiffness data confirmed an increased lateral stiffness compared to the medial stiffness.

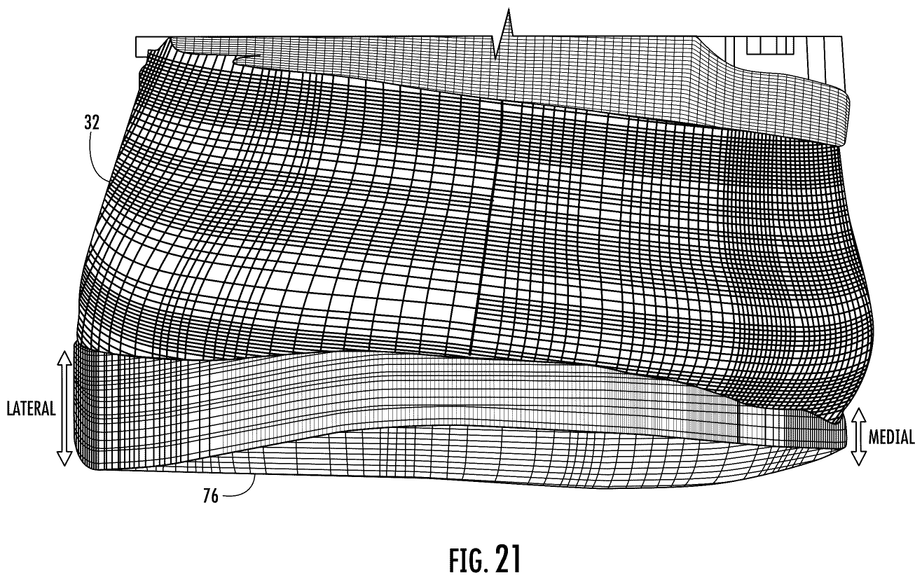

Referring to FIG. 21, a method of making a lateral wedge shoe sole 76 to control foot position is shown. A lateral wedge design is incorporated into the shoe sole shape 76. The higher lateral side of the show sole 76 positions the foot so it tilts from lateral side to the medial side. The porosity of the lateral wedge can be decreased to varying levels compared to the remainder of the shoe sole 76 to increase the lateral stiffness to further control the foot position by varying the bioinspired Vornoi point clouds, porosities, and stiffnesses.

In particular, a curve encircling the bottom of the shoe sole and using the command CurveBoolean to close the curve using Rhino 3D software is created. The curve is extruded into a surface and using the command BooleanSplit to split the shoe sole into two parts along the curve. The bottom of the shoe sole is extruded 10 mm. A guiding line angled at the desired wedge angle is created. A line is extruded to a surface and using the command BooleanSplit to cut the extruded bottom of the sole into a wedge shape. A cage edit is used to shape the wedge to the shoe sole. The wedge will have a higher stiffness than the other portions of the shoe sole, which is controlled by previously described claims related to varying bioinspired Vornoi point clouds, porosities, and stiffnesses.

Therefore, it can be seen that the present shoe sole based on biological lattices and method of making thereof, provides an improvement over prior art shoe soles.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A method of making a shoe sole, comprising:
imaging an irregular, but not random, lattice pattern, creating and imaged lattice;
generating a point cloud from the imaged lattice,
layering said point cloud over another point cloud, forming a staggered point cloud;
generating a wire frame of a shoe sole shape;
filling said wire frame with said staggered point cloud;
generating an irregular, but not random, lattice structure from the staggered point cloud within the wire frame to form a shoe sole model; and
additive manufacturing of a shoe sole from said shoe sole model.

2. The method of making a shoe sole of claim 1, further comprising:
removing floating architecture from said imaged lattice; and
filling gaps within the imaged lattice.

3. The method of making a shoe sole of claim 1, further comprising:
cropping edges from the point cloud to reduce instances of flat sheets.

4. The method of making a shoe sole of claim 1, further comprising:
scaling said point cloud to reduce porosity to a desired level.

5. The method of making a shoe sole of claim 1, wherein said step of generating a point cloud comprises generating Voronoi cell center points from the imaged lattice.

6. The method of making a shoe sole of claim 1, further comprising:
cropping said irregular, but not random, lattice structure of said shoe sole model to remove undesired structure from the lattice structure.

7. The method of making a shoe sole of claim 1, further comprising:
forming an upper substrate on an upper surface of said shoe sole, said upper surface and upper substrate contoured to receive a shoe upper. 8 The method of making a shoe sole of claim 7, wherein said step of forming an upper substrate on an upper surface of said shoe sole, comprises forming a ribbon of material about an outer edge of the upper surface of said shoe sole.

9. The method of making a shoe sole of claim 1, further comprising:
forming a bottom plate on a bottom surface of said shoe sole, configured to receive a shoe tread.

10. The method of making a shoe sole of claim 1, wherein the irregular lattice structure is varied throughout the shoe sole, with differing polyhedral cell properties, thereby exerting biomechanical control over a foot to control and correct for specific foot postures.

11. The method of making a shoe sole of claim 1, wherein the irregular lattice structure is formed from two differently scaled point clouds with differing polyhedral cell properties, thereby exerting biomechanical control over a foot to control and correct for specific foot postures.

12. The method of making a shoe sole of claim 1, further comprising forming a wedge with a higher side on one side of the shoe sole to control foot position.

13. A shoe sole, comprising:
an energy absorbing lattice structure, the energy absorbing lattice structure having an irregular, but not random, lattice pattern.

14. The shoe sole of claim 13, wherein the irregular lattice pattern of the energy absorbing lattice structure comprises a Voronoi cell pattern.

15. The shoe sole of claim 13, further comprising an upper substrate formed on an upper surface of the energy absorbing lattice structure configured and arranged to receive a shoe upper.

16. The shoe sole of claim 13, further comprising a bottom plate formed on a bottom surface of the energy absorbing lattice structure configured and arranged to receive a shoe tread.

17. The shoe sole of claim 13, wherein said energy absorbing lattice structure is varied throughout the entire shoe sole, with differing polyhedral cell properties, thereby exerting biomechanical control over a foot to control and correct for specific foot postures.

18. The shoe sole of claim 13, wherein said energy absorbing lattice structure is formed from two differently scaled point clouds, with differing polyhedral cell properties, thereby exerting biomechanical control over a foot to control and correct for specific foot postures.

19. The shoe sole of claim 18, wherein the two differently scaled point clouds are formed adjacent to one another, bisecting the shoe sole with two differing energy absorbing lattice structures.

20. The show sole of claim 13, wherein said energy absorbing lattice structure includes a wedge on one side, higher than the other side of the lattice structure to control foot posture.
